(19) United States
(12) Patent Application Publication
(10) Pub. No.: US 2009/0268038 A1
(43) Pub. Date: Oct. 29, 2009

(54) IMAGE CAPTURING APPARATUS, PRINT SYSTEM AND CONTENTS SERVER

(75) Inventor: Tetsuya Matsumoto, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/065,844

(22) PCT Filed: Sep. 5, 2006
(86) PCT No.: PCT/JP2006/317940

§ 371 Date: Oct. 27, 2008

(30) Foreign Application Priority Data
Sep. 6, 2005 (JP) 2005-258155

(51) Int. Cl. H04N 5/225; G06F 3/12; G06F 17/00

(52) U.S. Cl. 348/207.1; 358/1.15; 707/104.1; 707/E17.001

(57) ABSTRACT

The image capturing apparatus includes: an imaging device which outputs an image signal according to object light received through a taking lens; an image storage device which stores a still image according to the image signal outputted by the imaging device; a contents storage device which stores contents including at least one of a sound and a moving image; an operating device which receives manual input operation; a mode specification device which receives specification of either a first mode in which the still image and the contents that are to be linked with each other are automatically selected, and a second mode in which the still image and the contents that are to be linked with each other are freely selected by means of the manual input operation to the operating device; and a linkage information creating device which creates linkage information that links the still image and the contents selected.

### TECHNICAL FIELD

The present invention relates to technology for linking still images with contents of various types, and providing contents of various types linked with still images that have been printed.

### BACKGROUND ART

In recent years, various technologies have been developed for presenting print having added audio information. For example, Japanese Patent Application Laid-Open No. 2003-324682 discloses that audio data which is different to image data is embedded into the bits of the image data which contain large noise components, and an image is recorded on printing paper, thereby creating a print, on the basis of the image data having the embedded audio data. The audio data can be read out by capturing an image of the print thus created, by means of an image capturing device.

Japanese Patent Application Laid-Open No. 2005-108200 discloses that an image and additional information, such as audio information added to the image, which have been uploaded from a mobile telephone equipped with a camera, are managed in a database on a service server. A URL (uniform resource locator) for accessing the additional information is issued, and this URL is converted into a two-dimensional code. The two-dimensional code and order information including the image are sent to a printing apparatus, and the image and the two-dimensional code are printed onto printing paper, thereby creating a photographic print. When the two-dimensional code on the photographic print is read in by a camera-equipped mobile telephone, and an access operation is performed using the URL obtained by decoding the two-dimensional code, then the additional information of the image managed in relation to that URL is read out from the database and sent to the camera-equipped mobile telephone through which the access operation has been performed.

### DISCLOSURE OF THE INVENTION

In the technology disclosed in Japanese Patent Application Laid-Open No. 2003-324682, since the audio data is embedded into the image, there are problems relating to data volume. In the technology disclosed in Japanese Patent Application Laid-Open No. 2005-108200, since the image and audio files are automatically linked with each other by using a common portion in their filenames, then the task of deciding which image is linked with which sound is reduced, but on the other hand, there may be cases where it is not appropriate that comment sounds inputted at the time of capturing a particular image should be linked simply with that image.

The present invention has been contrived in view of such circumstances, an object thereof being to provide technology which links a sound captured by the user at the same time as image capturing, or a desired sound recorded independently from the moment of image capturing, with a still image or an image that is to be printed.

In order to attain the aforementioned object, the present invention is directed to an image capturing apparatus, comprising: an imaging device which outputs an image signal according to object light received through a taking lens; an image storage device which stores a still image according to the image signal outputted by the imaging device; a contents storage device which stores contents including at least one of a sound and a moving image; an operating device which receives manual input operation; a mode specification device which receives specification of either a first mode in which the still image and the contents that are to be linked with each other are automatically selected, and a second mode in which the still image and the contents that are to be linked with each other are freely selected by means of the manual input operation to the operating device; a contents selecting device which, when the mode specification device has received the specification of the first mode, selects the still image and the contents that are to be linked with each other, according to prescribed rules, and which, when the mode specification device has received the specification of the second mode, selects the still image and the contents that are to be linked with each other, according to the manual input operation to the operating device; and a linkage information creating device which creates linkage information that links the still image and the contents selected by the contents selecting device.

According to this aspect of the present invention, when the user selects the first mode, the still image and the contents (including at least one of a moving image and/or sound) are linked with each other in accordance with prescribed rules. When the user selects the second mode, the user him or herself is able to freely select the still image and the contents that are to be linked with each other. In this way, in the present invention, the user freely selects the first mode or second mode, and hence is able to select either an automatic method or a manual method, for the method of linking the still image and the contents.

Preferably, when the mode specification device has received the specification of the first mode, the contents selecting device selects the still image and the contents that are to be linked with each other, according to proximity between date and time at which the still image has been recorded and date and time at which the contents have been recorded.

Preferably, the contents selecting device comprises a display device which, when the mode specification device has received the specification of the second mode, successively displays still images stored in the image storage device, according to the manual input operation to the operating device, as well as displaying a list of contents identification information that identifies, in the contents storage device, the contents to be linked with the displayed still image.

The contents identification information can be the filename, file storage location, or the like, and it can be stated as a file path, URL, or the like.

Preferably, the contents selecting device selects the contents identified by the contents identification information selected according to the input operation to the operating device, as the contents that are to be linked with the displayed still image.

According to this aspect of the present invention, by selecting prescribed contents identification information from a list of contents identification information, it is possible readily to select contents that are to be linked with a still image, thus providing convenience.

Preferably, the linkage information includes information that identifies a storage location of the contents in one of the contents storage device and an external contents server.

According to this aspect of the present invention, even if the contents are stored in an external server, it is possible to access the contents on the basis of the two-dimensional code.

Preferably, the image capturing apparatus further comprises a code creating device which creates a two-dimensional code embedded with the linkage information.

Preferably, the image capturing apparatus further comprises: a reading device which reads the linkage information from the two-dimensional code; and a reproduction device which reads out and reproduces, by one of making audible through a speaker and displaying on a display device, the contents identified by the information that identifies the storage location of the contents included in the linkage information read out by the reading device, from the one of the contents storage device and the external contents server.

Preferably, the linkage information includes information that identifies a storage location of the still image in the image storage device; and the display device displays the still image identified by the information that identifies the storage location of the still image included in the linkage information, simultaneously with reproduction of the contents by the reproduction device.

In order to attain the aforementioned object, the present invention is also directed to a print system which creates print data for printing a two-dimensional code embedded with linkage information that links a still image and contents with each other, and the still image linked with the contents by the linkage information embedded in the two-dimensional code, and which prints the two-dimensional code and the still image on a prescribed print medium according to the print data.

In order to attain the aforementioned object, the present invention is also directed to a contents server which stores contents in a storage location represented with information included in linkage information that links a still image and the contents with each other, and which sends the contents to a communication terminal that accesses to the contents server according to the linkage information embedded in a two-dimensional code printed on a prescribed print medium.

According to this aspect of the present invention, the two-dimensional code embedded with information identifying the storage location of the contents linked with the still image is printed onto the prescribed print medium, and when this print medium is distributed, it is possible to access the contents server by means of a communication terminal having a two-dimensional code reading device, and to obtain the contents linked with the still image. Accordingly, it is possible to experience the contents linked with the still image, while viewing the still image printed on the print medium.

As described above, according to the present invention, when the user selects the first mode, the still image and the contents are linked in accordance with a prescribed rule. When the user selects the second mode, the user him or herself is able to freely select the still image and contents that are to be linked with each other. In this way, in the present invention, the user freely selects the first mode or second mode, and hence is able to select either an automatic method or a manual method, for the method of linking the still image and the contents.

### BRIEF DESCRIPTION OF THE DRAWINGS

FIG. 1 is a front view of a digital camera according to an embodiment of the present invention;

FIG. 2 is a rear view of the digital camera;

FIG. 3 is a schematic block diagram of the digital camera;

FIG. 4 is a flowchart showing the sequence of an automatic linkage operation;

FIG. 5 is a diagram showing an embodiment of linkage between still image data and audio data;

FIG. 6 is a conceptual diagram of linkage data;

FIG. 7 is a flowchart showing the sequence of a manual linkage operation;

FIG. 8 is an embodiment of display of a list of still images and file names;

FIG. 9 is an embodiment of display of an icon indicating that still image data has been linked with an audio/video file;

FIG. 10 is a general schematic drawing of a contents presenting system according to an second embodiment of the present invention; and

FIG. 11 is a flowchart showing a sequence of the operation of the contents present system.

### DESCRIPTION OF SYMBOLS

100 . . . camera
300 . . . contents server
400 . . . print server
500 . . . printer
600 . . . mobile telephone

### BEST MODE FOR CARING OUT THE INVENTION

In the following, preferred embodiments of the present invention are described in detail with reference to the attached drawings.

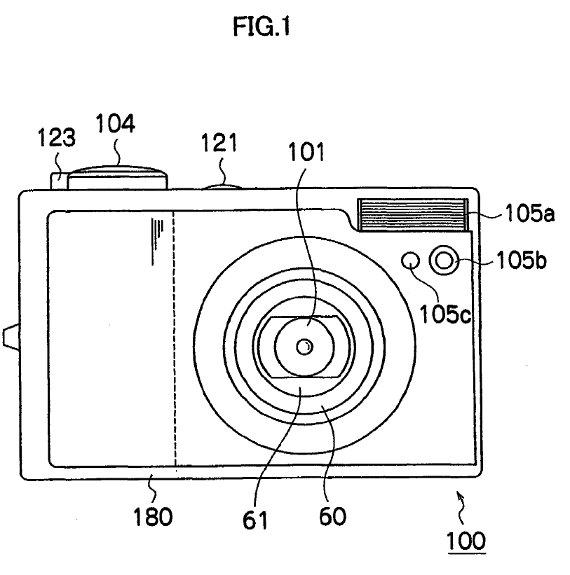

FIG. 1 is a front view of a digital camera (hereinafter referred simply to as “camera”) 100 according to a preferred embodiment of the present invention.

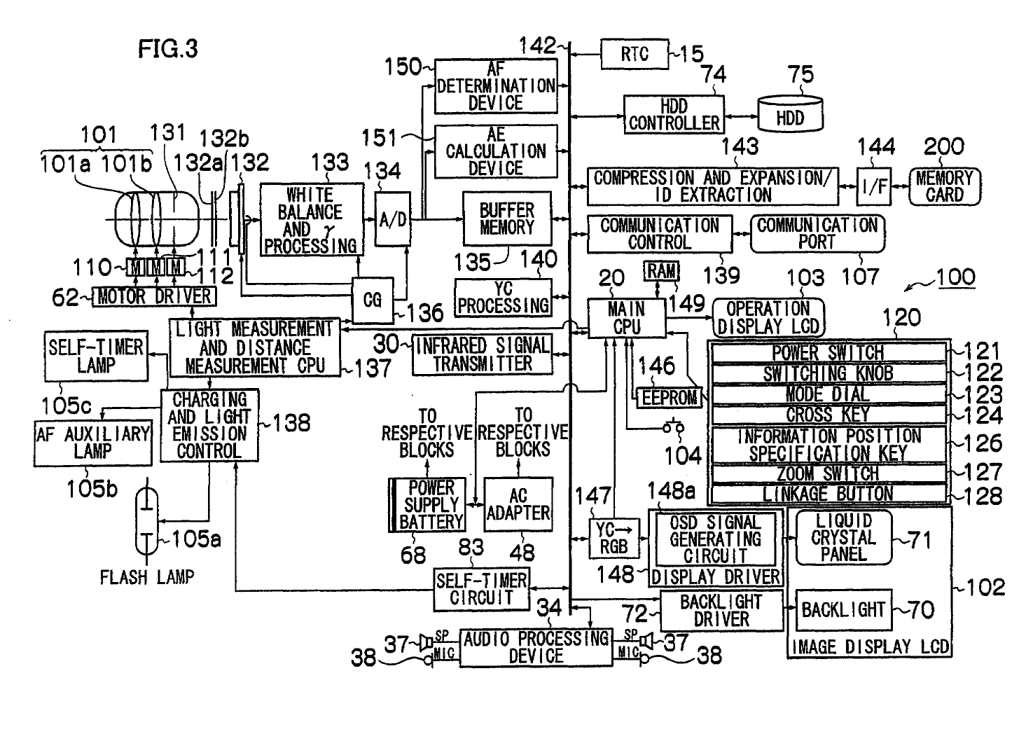

A taking lens 101 including a zoom lens 101a and a focusing lens 101b (see FIG. 3) is arranged in a lens barrel 60, which is provided on the front side of the camera 100. The focal length can be adjusted by moving the zoom lens 101a along the optical axis, and the focus can be adjusted by moving the focusing lens 101b along the optical axis.

The lens barrel 60 can be accommodated inside a camera body 180. From a state where the lens barrel 60 collapses in the camera body 180, the lens barrel 60 can be extended from the camera body 180 to advance and retract between a predetermined wide angle end, which is the shortest possible focal length position, and a predetermined telephoto end, which is the longest possible focal length position. FIG. 1 shows a state in which the lens barrel 60 is retracted inside the camera body 180.

The camera 100 has a lens cover 61, which covers the front face of the taking lens 101 and shields the taking lens 101 from the exterior to protect the taking lens 101 when no image is captured, whereas exposes the taking lens 101 to the exterior when capturing images.

The lens cover 61 is constituted by an openable and closable mechanism, and it covers the front face of the taking lens 101 when in an open state, whereas it exposes the front face of the taking lens 101 to the exterior, when in a closed state. The lens cover 61 is opened and closed in conjunction with the on/off operation of a power switch 121. In FIG. 1, the lens cover 61 is in the open state.

A mode dial 123 provided with a shutter release switch 104 in the central portion thereof, and the power switch 121, are arranged on the upper face of the camera 100. An electric flash lamp 105a, an autofocus auxiliary lamp 105b, a self-timer lamp 105c, and the like, are arranged on the front face of the camera 100.

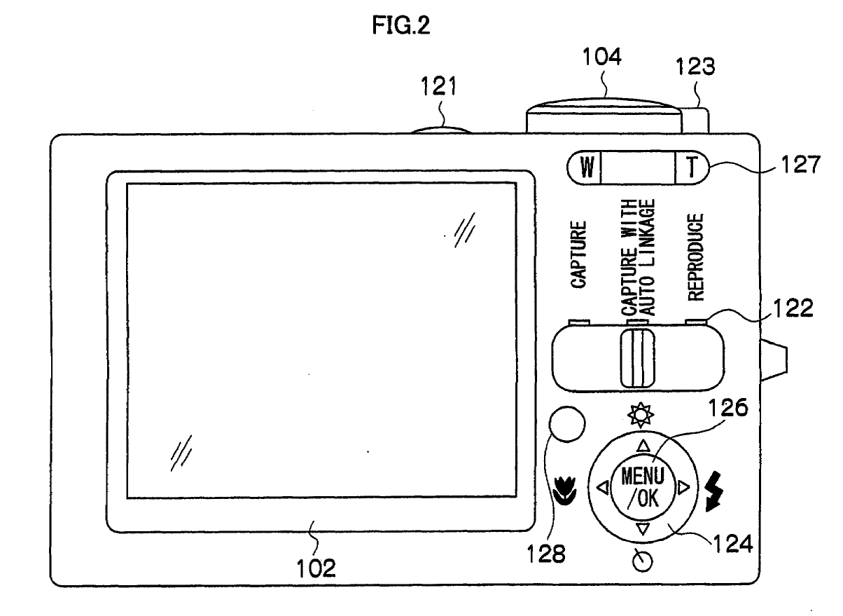

FIG. 2 is a rear view of the camera 100. A switching knob 122 which can be switched between “capture”, “capture with automatic linkage” and “reproduce”, is arranged on the rear face of the camera 100. A linkage button 128 is arranged on the rear face of the camera 100. As described below, the linkage button 128 is a button which instructs to link a desired still image with a desired sound or moving image, or both, when the switching knob 122 is set to “reproduce”.

An image display LCD (liquid-crystal display) 102, a cross key 124, and an information position specification key 126, and the like, are also arranged on the rear face of the camera 100. The cross key 124 is an operating member, in which operations at the upper, lower, left-hand and right-hand positions respectively set the display brightness adjustment, the self-timer, the macro image capturing, and the image capturing with flash lamp. As described below, by pressing the lower key of the cross key 124, a self-image capturing mode is set where a main CPU 20 causes a shutter-releasing operation to be performed in a CCD 132 when the countdown by a self-timer circuit 83 is completed.

A zoom switch 127 is arranged on the rear face of the camera 100. When a wide-angle (W) side of the zoom switch 127 is pressed, then for as long as it is pressed, the lens barrel 60 moves toward the wide-angle end, and when a telephoto (T) side of the zoom switch 127 is pressed, then for as long as it is pressed, the lens barrel 60 moves toward the telephoto end.

FIG. 3 is a block diagram of the camera 100. The camera 100 is provided with an operating device 120 whereby the user can perform various operations when using the camera 100. The operating device 120 includes: the power switch 121 for switching on the power supply in order to operate the camera 100; the switching knob 122 which can be switched between “capture”, “capture with automatic linkage” and “reproduce”; the mode dial 123 for selecting automatic capture, manual capture, and the like; the cross key 124 for selecting and setting various menus including an on/off of the flash light emission, and performing a zoom; and the information position specification key 126 for executing and canceling the menu selected by the cross key 124, and the like.

The camera 100 also comprises: the image display LCD 102 for displaying a captured image or reproduced image, or the like, and an operation display LCD 103 for aiding the operation of the camera 100.

The shutter release switch 104 is also provided in the camera 100. An instruction for starting image capture is supplied to the main CPU 20 by the shutter release switch 104. The camera 100 can be switched freely between “capture”, “reproduce”, and the like, by means of the switching knob 122, and when performing image capture, the switching knob 122 is switched to the capture position by the user, and when reproducing images, the switching knob 122 is switched to the reproduce position. Furthermore, the camera 100 also comprises a flash light emitting device including the electric flash lamp 105a which emits a flash light.

The camera 100 further comprises: the taking lens 101, an aperture 131, and the CCD (charge-coupled device) sensor 132 (hereinafter, abbreviated to CCD 132), which is an imaging element that converts the object image formed through the taking lens 101 and the aperture 131 into an analog image signal. More specifically, the CCD 132 generates an image signal by accumulating electrical charges generated by the light of the object image formed on the CCD 132, during a variable electrical charge accumulating time period (exposure time period). From the CCD 132, image signals for frames are outputted successively at timing synchronized with vertical synchronization signals VD outputted from a clock generator (CG) device 136.

If the CCD 132 is used for the imaging element, in order to prevent the occurrence of color pseudo-signals, moire patterns, and the like, an optical low-pass filter 132a which removes unnecessary high-frequency components in the incident light is provided. Furthermore, an infrared cutting filter 132b which absorbs or reflects infrared light in the incident light and thus compensates for the intrinsic sensitivity characteristics of the CCD sensor 132, which has high sensitivity in the longer wavelength region. The specific mode of disposing the optical low-pass filter 132a and the infrared cutting filter 132b is not limited in particular.

The camera 100 also comprises a white balance and γ processing device 133, which adjusts the white balance of the object image represented by the analog image signal from the CCD sensor 132, as well as adjusting the inclination (γ) of the straight line in the tonal graduation characteristics of the object image. The white balance and γ processing device 133 includes an amplifier with a variable amplification rate, which amplifies the analog image signal.

The camera 100 also comprises an A/D device 134, which performs analog-digital (A/D) conversion of the analog signal from the white balance and γ processing device 133 into digital R, G, B image data; and a buffer memory 135, which stores the R, G, B image data outputted from the A/D device 134.

In the present embodiment, the A/D device 134 has an 8-bit quantization resolution, and converts the analog R, G, B imaging signals outputted from the white balance and γ processing device 133 into R, G, B digital image data having a level of 0 to 255, which is then outputted. However, this quantization resolution is simply an example and it is not an essential value in the present invention.

The camera 100 also comprises: the CG device 136, a light measurement and distance measurement CPU 137, a charging and light emission control device 138, a communication control device 139, a YC processing device 140, an infrared signal transmitter 30, and a power supply battery 68.

The CG device 136 outputs control signals including the vertical synchronization signal VD and a high-speed sweeping pulse P for driving the CCD sensor 132, control signals which control the white balance and γ processing unit 133 and the A/D device 134, and a control signal which controls the communication control device 139. Furthermore, a control signal from the light measurement and distance measurement CPU 137 is inputted to the CG device 136.

The light measurement and distance measurement CPU 137 performs measurement of object distance by driving the zoom lens 101a, the focusing lens 101b and the aperture 131, by controlling a zoom motor 110, a focusing motor 111, and an aperture motor 112 for adjusting the aperture 131, respectively, and controls the CG device 136 and the charging and light emission control device 138. The driving of the zoom motor 110, the focusing motor 111 and the aperture motor 112, is controlled through a motor driver 62, and the control commands for the motor driver 62 are sent by the light measurement and distance measurement CPU 137 or the main CPU 20.

When the shutter release switch 104 is pressed halfway down (SW1 on), the light measurement and distance measurement CPU 137 measures the brightness of the object (calculating an EV value) on the basis of the image data obtained at regular intervals (between 1/30 seconds and 1/60 seconds) by the CCD 132.

More specifically, an AE calculation device 151 integrates the R, G and B image signals outputted by the A/D conversion device 134, and provides the integration values to the light measurement and distance measurement CPU 137. The light measurement and distance measurement CPU 137 then determines the average brightness (luminosity) of the object, on the basis of the integration values inputted from the AE calculation device 151, and calculates an exposure value (EV value) suitable for image capture.

According to the obtained EV value, the light measurement and distance measurement CPU 137 then determines an exposure value including the aperture value (F value) of the aperture 131 and the electronic shutter speed of the CCD 132, in accordance with a prescribed program chart (AE operation).

When the shutter release switch 104 is pressed fully (SW2 on), then the light measurement and distance measurement CPU 137 drives the aperture 131 on the basis of the determined aperture value, thereby controlling the diameter of the opening of the aperture 131, and controls the electrical charge accumulation time period in the CCD 132 through the CG device 136, on the basis of the determined shutter speed.

The AE operation includes aperture-priority AE, shutter speed-priority AE, a program AE, or the like. In any of these cases, the object luminosity is measured, and an image is captured using the exposure value, in other words, a combination of the aperture value and the shutter speed, determined on the basis of the measured value of the object luminosity. In this way, control is implemented in such a manner that the image is captured at a suitable exposure quantity, and hence the user does not need to perform bothersome exposure setting tasks.

An AF determination device 150 extracts image data corresponding to the determination range selected by the light measurement and distance measurement CPU 137, from the A/D conversion unit 134. The method of determining the focusing position uses the characteristic that the high-frequency component of the image data reaches a maximum amplitude at the focusing position. The AF determination device 150 calculates the amplitude value by integrating the high-frequency component of the extracted image data for the period of one field. The AF determination device 150 successively calculates amplitude values, while the light measurement and distance measurement CPU 137 drives and controls the focusing motor 111 and causes the focusing lens 101b to move within its movement range, in other words, from the infinity end point (INF point) to the nearside end point (NEAR point), so that the AF determination device 150 sends the value determined for the maximum amplitude to the light measurement and distance measurement CPU 137.

The light measurement and distance measurement CPU 137 sends an instruction to the focusing motor 111 so as to move the focusing lens 101b to the focusing position corresponding to the position at which the maximum value is determined. The focusing motor 111 moves the focusing lens 101b to the focusing position in accordance with the instruction from the light measurement and distance measurement CPU 137 (AF operation).

The light measurement and distance measurement CPU 137 is connected to the shutter release switch 104 through inter-CPU communication with the main CPU 20, and when the shutter release switch 104 is half-pressed by the user, the focusing position is determined. Furthermore, the light measurement and distance measurement CPU 137 is connected to the zoom motor 110, and when the main CPU 20 receives a zoom instruction in the TELE direction or the WIDE direction from the user through the zoom switch 127, then the light measurement and distance measurement CPU 137 drives the zoom motor 110 to move the zoom lens 101a between the WIDE end and the TELE end.

The charging and light emission control device 138 controls the charging of a capacitor (not shown) for the flash lamp by receiving a power supply from the power supply battery 68, in order to cause the flash lamp 105a to emit a flash, as well as controlling the emission of a flash by the flash lamp 105a.

The charging and light emission control device 138 receives various signals, such as the start of charging of the power supply battery 68, or half-pressing or full-pressing operating signals of the shutter release switch 104, or signals indicating the light emission quantity or light emission timing, from the main CPU 20 or the light measurement and distance measurement CPU 137, then the charging and light emission control device 138 controls the supply of current to the self-timer lamp 105c or the AF auxiliary lamp 105b, in such a manner that a desired light emission quantity is obtained at the desired timing.

More specifically, when the charging and light emission control device 138 receives a high (H) level signal from the main CPU 20 or the light measurement and distance measurement CPU 137, then the current is supplied to the self-timer lamp 105c, which lights up. On the other hand, when the charging and light emission control device 138 receives a low (L) level signal, then the current to the self-timer lamp 105c is halted, and the lamp is turned off.

The main CPU 20 or the light measurement and distance measurement CPU 137 alters the luminosity (brightness) of the self-timer lamp 105c by varying the ratio of the output duration of the H and L level signals (the duty ratio).

The self-timer lamp 105c may be constituted by an LED (light-emitting diode), and a common LED may be used as the self-timer lamp 105c and the AF auxiliary lamp 105b.

The self-timer circuit 83 is connected to the main CPU 20. If the self-capture mode is set, then the main CPU 20 starts a time count on the basis of the full-pressing signal of the shutter release switch 104. During this time count, the main CPU 20 causes the self-timer light 105c to flash on and off, through the light measurement and distance measurement CPU 137 at a flashing rate that increases gradually in accordance with the remaining time. The self-timer circuit 83 inputs a time count completion signal to the main CPU 20 when the time count has been completed. On the basis of this time count completion signal, the main CPU 20 causes the CCD 132 to perform a shutter operation.

The communication control device 139 is provided with a communication port 107, and the communication control device 139 serves to perform data communications with an external apparatus, such as a personal computer equipped with a USB (universal serial bus) terminal, by outputting an image signal of the object captured by the camera 100 to the external apparatus, or inputting image signals to the camera 100 from the external apparatus. The camera 100 has a function which imitates the function of changing between ISO sensitivities 100, 200, 400, 1600, and the like, in a standard camera which takes photographs onto rolled photographic film. If the camera 100 is switched to ISO sensitivity 400 or above, then a high-sensitivity mode is established in which the amplification rate of the amplifier in the white balance and γ processing device 133 is set to a high amplification rate exceeding the prescribed amplification rate. The communication control device 139 halts communications with external apparatuses during image capture in the high-sensitivity mode.

The camera 100 is also provided with a compression and expansion and ID extraction device 143, and an I/F device 144. The compression and expansion and ID extraction device 143 reads out, through a bus line 142, the image data stored in the buffer memory 135, compresses the read image data, and stores the compressed image data on a memory card 200 through the I/F device 144. Furthermore, when reading out image data stored on the memory card 200, the compression and expansion and ID extraction device 143 extracts the unique identification (ID) number of the memory card 200, reads out and expands the image data stored on that memory card 200, and then stores the expanded data in the buffer memory 135.

The Y/C signal stored in the buffer memory 135 is compressed according to a prescribed format by the compression and expansion and ID extraction device 143, and is then recorded in a prescribed format (for example, an Exif (Exchangeable Image File. Format) file), through the I/F device 144, onto a removable medium such as the memory 200, or onto a built-in large-capacity storage medium, such as a hard disk (HDD) 75. The recording of data to the hard disk (HDD) 75 or the reading in of data from the hard disk (HDD) 75 is controlled by a hard disk controller 74 in accordance with instructions from the main CPU 20.

The camera 100 is also provided with the main CPU 20, an EEPROM 146, a YC/RGB conversion device 147, and a display driver 148 including an on-screen display (OSD) signal generating circuit 148a. The main CPU 20 controls the whole of the camera 100. Fixed data that is intrinsic to the camera 100, and programs, and the like, are stored in the EEPROM 146. The YC/RGB conversion device 147 converts the color image signal YC generated by the YC processing device 140, into a three-color RGB signal, which is then outputted to the image display LCD 102 through the display driver 148.

Furthermore, the camera 100 is composed in such a manner that an AC adapter 48 for supplying power from an AC power source, and the power supply battery 68, can be attached to and detached from the camera 100. The power supply battery 68 is a rechargeable secondary cell, such as a nickel-cadmium battery, nickel-hydrogen battery, or lithium ion battery, for example. The power supply battery 68 may also be constituted by a disposable primary cell, such as a lithium battery, an alkaline battery, or the like. The power supply battery 68 is installed into a battery accommodating space (not shown), whereby it is connected electrically to the circuits of the camera 100.

When the AC adapter 48 is fitted to the camera 100 and power is supplied to the camera 100 from an AC power source through the AC adapter 48, then even if the power supply battery 68 is fitted into the battery accommodating space, the power outputted from the AC adapter 48 is supplied preferentially to the various parts of the camera 100 as drive power. Furthermore, if the AC adapter 48 is not fitted and the power supply battery 68 is installed in the battery accommodating space, then the power outputted from the power supply battery 68 is supplied to the various parts of the camera 100 as drive power.

Although not shown in the drawings, the camera 100 is also provided with a back-up battery which is separate from the power supply battery 68 accommodated in the battery accommodating space. A special secondary cell, for example, is used for the internal back-up battery, and is charged by the power supply battery 68. The back-up battery supplies power to the basic functions of the camera 100, when the power supply battery 68 is not installed in the battery accommodating space, for instance when replacing or removing the power supply battery 68.

More specifically, when the power is supplied from nether the power supply battery 68 nor the AC adapter 48, then the back-up battery is connected through a switching circuit (not illustrated) to a real time clock (RTC) 15, and the like, and the back-up battery supplies power to the circuits. Consequently, provided that the back-up battery 29 is not used beyond its lifespan, the basic functions of the RTC 15, and the like, continue to receive a power supply, without interruption.

The RTC 15 is a dedicated clock chip, and even if the power supply from both the power supply battery 68 and the AC adapter 48 is turned off, the RTC 15 continues to operate by receiving a power supply from the back-up battery.

The image display LCD 102 is provided with a backlight 70, which illuminates a transparent or semi-transparent liquid crystal panel 71, and when in power-saving mode, the main CPU 20 controls the brightness (luminosity) of the backlight 70 through a backlight driver 72, in such a manner that the power consumption of the backlight 70 is reduced. Furthermore, the power-saving mode can be switched on and off by pressing the information position specification key 126 on the operating device 120, thereby displaying a menu screen on the image display LCD 102, and then performing prescribed operations on this menu screen.

An audio processing device 34 converts an audio signal inputted through microphones 38 into audio data of a prescribed format (MP3 (MPEG (Moving Picture Experts Group)-1 Audio Layer-3), or the like). This audio data is stored in a RAM (random-access memory) 149. On the other hand, the digital audio data stored in the RAM 149 is converted into an analog signal by the audio processing unit 34, whereupon it can then be reproduced by sending the signal to speakers 37.

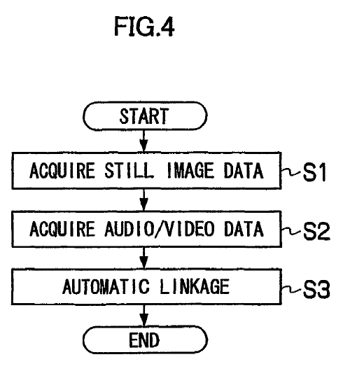

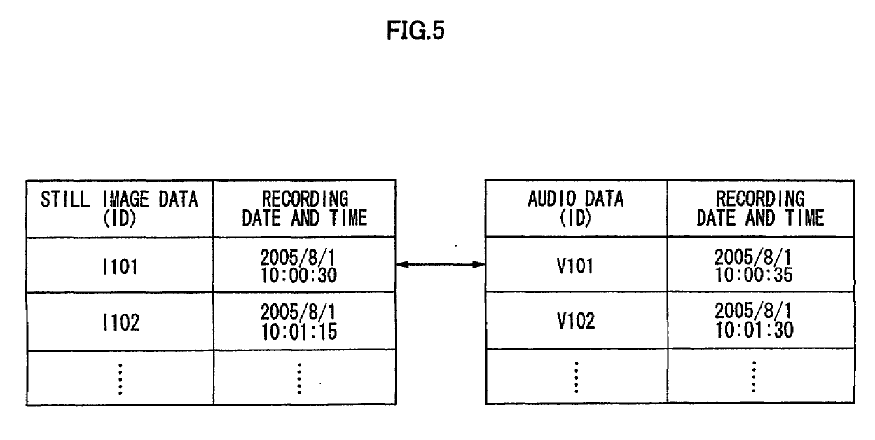

Below, the sequence of a linkage operation performed by the camera 100 is described in accordance with the flowcharts in FIGS. 4 and 5.

FIG. 4 shows a sequence of an automatic linkage operation. This operation links a still image file with an audio/video file, in accordance with the proximity of the recording date and time.

Firstly, if the “capture with automatic linkage” is selected with the switching knob 122 and the shutter release switch 104 is fully pressed, then the acquisition of still image data from the CCD 132 is started. This still image data is stored in the buffer memory 135, together with an attached time stamp (recording date and time) (S1).

When the storage of the still image data has been completed, subsequently, acquisition of audio data and/or video data (hereinafter referred to as “audio/video data”) is started. The acquisition of audio data is carried out by means of the microphone 38 and the audio processing unit 34, and the acquisition of video data is carried out by means of the CCD 132 and the A/D conversion device 134. The acquisition duration for the audio/video data may be optional, or it may be fixed (to 10 seconds, for instance). It is also possible that the user specifies the start and end of the acquisition process, as he or she desires, through the operating device 120. A time stamp (recording date and time) is appended to the audio/video data acquired in this step, and it is then stored on the memory card 200. The audio/video data may be stored on the memory card 200 by another electronic apparatus, such as a personal computer, mobile telephone, or the like, and it is not necessary to limit the stored data to data that is created and stored by the camera 100 itself.

When the storage of the still image data in the buffer memory 135 and the storage of the audio/video data on the memory card 200 have been completed, the CPU 20 compares the time stamps of the still image data and the audio/video data, and the CPU 20 creates data (linkage data) that links the audio/video data and the still image data having the closest recording dates and times as indicated by the time stamps (S3).

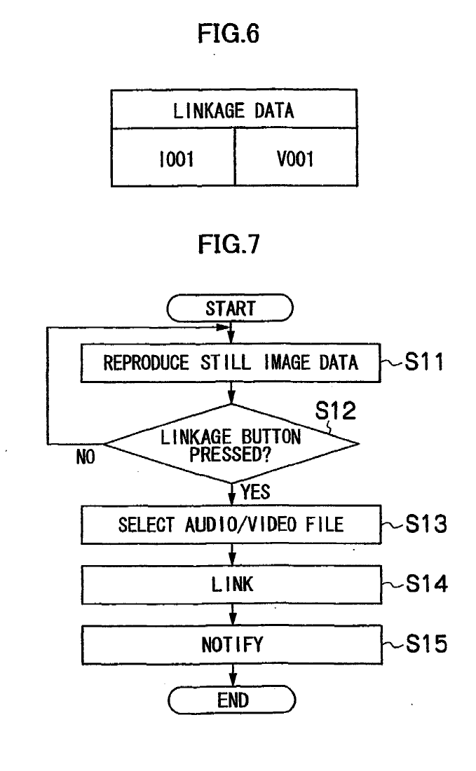

For example, as shown in FIG. 5, it is supposed that still image data and audio data having a difference within 5 seconds in the recording date and time are linked with each other. In this case, as shown in FIG. 6, the linkage data includes the identification (ID) information of the still image data and the ID information of the audio data. If there exist a plurality of pieces of audio/video data that have differences in terms of their recording dates and times within the prescribed interval (for example, 5 seconds) with respect to the recording date and time of particular still image data, then it is possible to group these together and link them in a plural fashion with respect to the particular one piece of still image data.

When the creation of the linkage data has been completed, the still image data and the linkage data are compressed and converted into prescribed formats (the still image data into the Exif, and the linkage data into the CSV (comma-separated values) file format, or the like), and they are stored on the memory card 200 together with the audio/video data.

It is also possible that the CPU 20 creates two-dimensional code embedded with the linkage data, and stores this on the memory card 200.

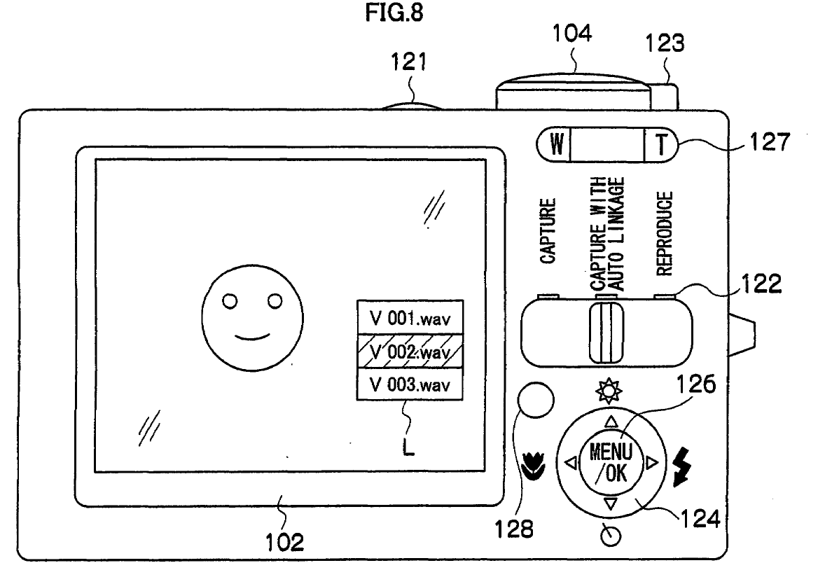

FIG. 7 shows a sequence of a manual linkage operation. This operation links a desired image file with a desired audio/video file, according to the pressing of the linkage button 128.

Firstly, when the “reproduce” is selected with the switching knob 122, the CPU 20 reads out the still image data stored in the buffer memory 135 (which may be the memory card 200, hereinafter referred to as “buffer memory 135, or the like”) and displays the still image on the LCD 102. The still images are reproduced frame by frame in the forward direction or reverse direction, in accordance with the pressing of the left or right button of the cross key 124, and they are displayed successively, one image at a time (S11).

When the linkage button 128 is pressed while a desired still image is being displayed (S12), then the processing in S13 starts. In S13, if a plurality of audio/video files are stored on the memory card 200, then a list L of the filenames of the audio/video files stored on the memory card 200 is displayed in addition to the still image on the LCD 102 (see FIG. 8), and the user selects the filename of one of the audio/video files that is to be linked with the sill image data from the list L, by operating the cross key 124 and the information position specification key 126.

When the information position specification key 126 is pressed in a state where the cursor is placed by means of the cross key 124 over the audio/video file name that is to be linked (in FIG. 8, a state where the cursor is placed over “V002.wav”), then the CPU 20 creates linkage data which links the audio/video file selected by the cursor with the still image data displayed on the LCD 102 (S14).

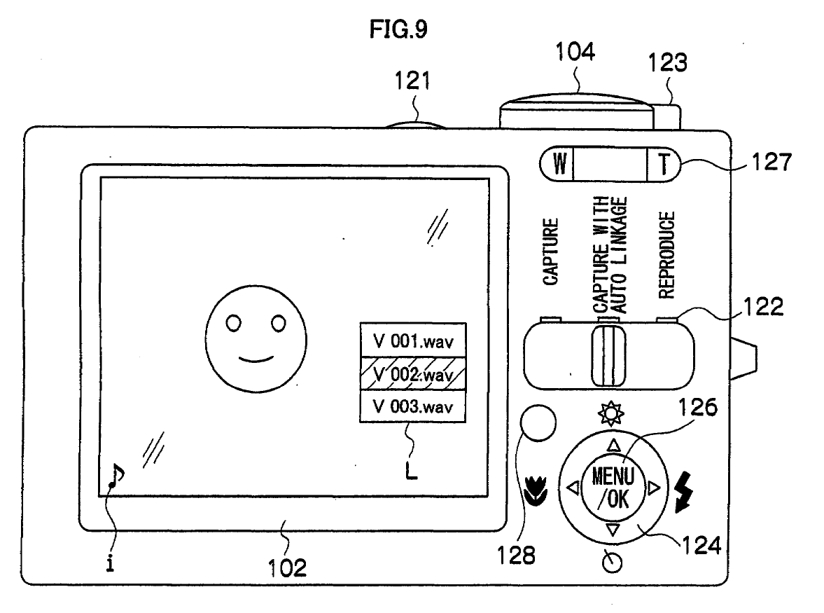

When the creation of the linkage data has been completed, the CPU 20 displays, on the LCD 102, an icon i that indicates that the still image data currently displayed has been linked with an audio/video file, as shown in FIG. 9 (S15). The indication of the linkage is not limited to displaying the icon, and it is also possible, for example, to output by the audio processing unit 34 an analog audio signal of a prescribed chime sound, or the like, to the speaker 37, thereby reproducing the chime sound. Furthermore, in step S11, if the selected and displayed still image data has already been linked with an audio/video file, then it is possible to report this linkage at step S11.

As described above, in the camera 100 according to the present invention, it is possible to link a desired captured still image with audio/video data stored on the memory card 200, either automatically according to prescribed rules, or manually on the basis of an operation by the user. The linkage between the still image and the file is specified by the linkage data created by the CPU 20. The linkage data is stored on the memory card 200, and therefore it is transportable and can be read out and used by a print server, or the like, as described below. The linkage data may be represented with two-dimensional code.

### Second Embodiment

As stated above, the camera 100 can converts the linkage data with two-dimensional code and store the two-dimensional code on the memory card 200. In this case, data indicating the access destination in an external contents server where the audio/video data linked with the still image data is stored, may be represented with two-dimensional code, together with the linkage data.

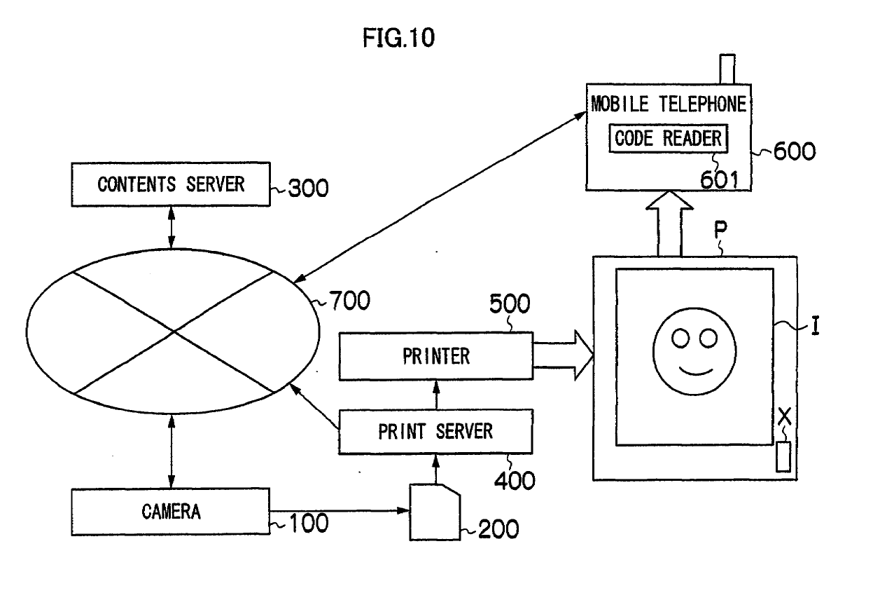

FIG. 10 is a general schematic view of a contents presenting system according to a second embodiment of the present invention. This system is constituted by connecting a contents server 300, a print server 400 and a mobile telephone 600, through a network 700 such as the Internet. The contents server 300 acquires audio/video data previously stored on the memory card 200, through the print server 400, or directly from the camera 100, and stores the acquired audio/video data in a prescribed storage location.

Information indicating the storage location of the audio/video data in the contents server 300 is embedded in a two-dimensional code X, such as a QR code, printed on the printed object P printed by a printer 500, and the storage location information can be read in by a code reader 601 provided in the mobile telephone 600.

The mobile telephone 600 can access the storage location read out by the code reader 601 from the two-dimensional code X, download the audio/video data from the contents server 300, and then reproduce the data. Furthermore, although not shown in the drawings, the mobile telephone 600 has a composition similar to the camera 100 including the image reproduction system having the image display LCD 102, and the like, and the audio reproduction system having the audio processing device 34, and the like.

One or a plurality of storage locations are specified in advance for each camera 100 or each user of each camera 100, and by embedding information indicating a specific storage location directly in the two-dimensional code X, and by storing the audio/video data in the specific storage location, then the linkage between the still image data and the audio/video data set in the camera 100 according to the first embodiment is maintained.

For example, information indicating a specific storage location for a particular-user is stored previously on the memory card 200 or another removable medium, and when actually storing the audio/video data in the contents server 300, then the specific storage location is displayed on the LCD 102, or the like, in such a manner that it can be referred to by the user. More specifically, text data which specifies a storage location for a particular user “user 1” is stored on the memory card 200, for instance, “ . . . /user1/data001” for the audio/video data stored with linkage to the image of the first frame, “ . . . /user1/data002” for the audio/video data stored with linkage to the image of the second frame, and so on. When storing new audio/video data, the text data on the memory card 200 is referenced, and a storage location corresponding to the frame number of the still image specified as desired through the operating device 120, is displayed. It is also possible to display the still image of the specified frame number, at the same time. In this way, audio/video data is stored in accordance with the displayed information relating to the specific storage location, and the linkage between the still image data and the audio/video data embedded in the two-dimensional code X is maintained.

Provided that the linkage between the still image data and the audio/video data designated by the linkage data is not lost, then the information indicating the storage location can be created in real time, and it does not necessarily have to be specified in advance. For example, a network-compatible application, such as “i-appli”, installed in the camera 100, requests the designation of the storage location of the audio/video data that is to be linked with the desired still image, in real-time, to the contents server 300. In response to this request, the contents server 300 reports the storage location, for instance, by mailing back an URL indicating the storage location, to the camera 100, or the like, and the network-compatible application can then upload the audio/video data to the reported storage location, as well as embedding the reported storage location in the two-dimensional code X.

Alternatively, the storage location established by an actual upload operation performed by the network-compatible application can be reported to the camera 100, each time an upload operation is performed, and the reported storage location can be embedded in the two-dimensional code X.

The still image I represented by the still image data is also printed on the printed object P. The still image data representing the still image I and the audio/video data stored at the storage location embedded in the two-dimensional code X are linked by the linkage data. The print server 400 reads out the still image data, the audio/video data and the linkage data from the memory card 200, which has been removed from the camera 100, and the print server 400 creates print data for printing the still image I represented by the still image data linked by a particular linkage data, and the two-dimensional code X that is embedded with the storage location of the audio/video data that is linked with the still image I by the linkage data. The print server 400 outputs this print data to the printer 500.

The printer 500 prints the still image I and the two-dimensional code X onto a prescribed print medium P, in accordance with the print data outputted from the print server 400. Desirably, the still image I and the two-dimensional code X are printed onto the same print medium P, but it is not essential that they be printed onto the same surface (i.e., the same front surface or the same rear surface).

The print server 400 and the printer 500 may be constituted by a commonly known shop-based print system.

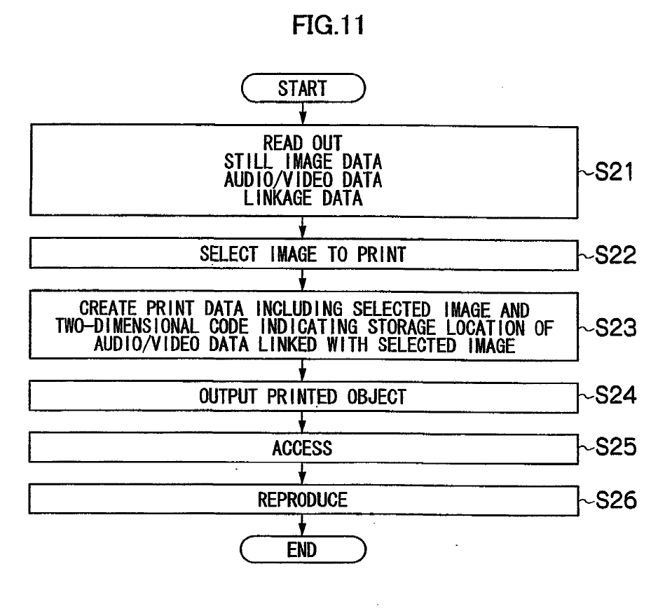

FIG. 11 is a flowchart showing a sequence of the operation of the present system.

Firstly, the user of the camera 100 removes the memory card 200 from the camera 100 and visits a place where the print server 400 is located (for example, a print service shop). The print server 400 reads out still image data, audio/video data, and linkage data, from the memory card 200 (S21).

The print server 400 receives the selection of the still image data to be printed, by means of various types of operating devices, such as a touch panel (S22).

When the selection of the still image data has been completed, the print server 400 uploads the audio/video data linked with the selected still image data to the contents server 300, in accordance with the linkage data. Furthermore, the print server 400 creates print data for printing the still image I represented by the selected still image data, and the two-dimensional code X embedded with information indicating the storage location of the audio/video data that is linked with the selected still image data by means of the linkage data. The print server 400 outputs the created print data to the printer 500 (S23).

It is also possible that the contents server 300 sends back the storage location of the audio/video data to the camera 100, in response to the uploading operation to the contents server 300, and the camera 100 represents the received storage location information with a two-dimensional code, together with the linkage information. Alternatively, it is possible that information indicating the storage location assigned in advance is stored in the memory card 200, and the camera 100 simply converts the information into the two-dimensional code.

The conversion of the linkage information and the storage location into the two-dimensional code may be carried out by the camera 100 or it may be carried out by the application server.

The printer 500 outputs a printed object P on which the still image I and the two-dimensional code X are printed, on the basis of the print data received from the print server 400 (S24). The printed object P is supplied to the user of the portable telephone 600 by the user of the camera 100.

The mobile telephone 600 reads the two-dimensional code X of the printed object P by the code reader 601, and then accesses the storage location in the content server 300 indicated by the two-dimensional code X, through the network 700. In response to the access operation from the mobile telephone 600, the contents server 300 sends the audio/video data stored in the storage location, to the mobile telephone 600 (S25).

The mobile telephone 600 reproduces the data, by either outputting the sound received from the contents server 300 to a speaker, or converting video data into an RGB signal and outputting same to a liquid crystal screen (S26). The user of the mobile telephone 600 is then able to experience the audio/video data linked with the still image I, on his or her mobile telephone 600, while viewing the still image I on the printed object P.

### Third Embodiment

Provided that the camera 100 has the code reader 601, it is possible to identify both the linked still image and audio/video data, from the linkage data represented with the two-dimensional code X on the printed object P. In this case, the camera 100 is able to reproduce the identified still image and the audio/video data, synchronously.

By so doing, the user of the camera 100 can experience the audio/video data that is linked the still image I, on the camera 100, at the same time as viewing the still image I on the printed object P, without having to use the contents server 300 and the network 700. Therefore, the audio/video data that is linked with the still image I does not need to be searched out severally by the user, and hence management of the data is extremely easy.

1. An image capturing apparatus, comprising:
an imaging device which outputs an image signal according to object light received through a taking lens;
an image storage device which stores a still image according to the image signal outputted by the imaging device;
a contents storage device which stores contents including at least one of a sound and a moving image;
an operating device which receives manual input operation;
a mode specification device which receives specification of either a first mode in which the still image and the contents that are to be linked with each other are automatically selected, and a second mode in which the still image and the contents that are to be linked with each other are freely selected by means of the manual input operation to the operating device;
a contents selecting device which, when the mode specification device has received the specification of the first mode, selects the still image and the contents that are to be linked with each other, according to prescribed rules, and which, when the mode specification device has received the specification of the second mode, selects the still image and the contents that are to be linked with each other, according to the manual input operation to the operating device; and
a linkage information creating device which creates linkage information that links the still image and the contents selected by the contents selecting device.

2. The image capturing apparatus as defined in claim 1, wherein, when the mode specification device has received the specification of the first mode, the contents selecting device selects the still image and the contents that are to be linked with each other, according to proximity between date and time at which the still image has been recorded and date and time at which the contents have been recorded.

3. The image capturing apparatus as defined in claim 1, wherein the contents selecting device comprises a display device which, when the mode specification device has received the specification of the second mode, successively displays still images stored in the image storage device, according to the manual input operation to the operating device, as well as displaying a list of contents identification information that identifies, in the contents storage device, the contents to be linked with the displayed still image.

4. The image capturing apparatus as defined in claim 3, wherein the contents selecting device selects the contents identified by the contents identification information selected according to the input operation to the operating device, as the contents that are to be linked with the displayed still image.

5. The image capturing apparatus as defined in claim 1, wherein the linkage information includes information that identifies a storage location of the contents in one of the contents storage device and an external contents server.

6. The image capturing apparatus as defined in claim 5, further comprising a code creating device which creates a two-dimensional code embedded with the linkage information.

7. The image capturing apparatus as defined in claim 6, further comprising:
a reading device which reads the linkage information from the two-dimensional code; and
a reproduction device which reads out and reproduces, by one of making audible through a speaker and displaying on a display device, the contents identified by the information that identifies the storage location of the contents included in the linkage information read out by the reading device, from the one of the contents storage device and the external contents server.

8. The image capturing apparatus as defined in claim 7, wherein:
the linkage information includes information that identifies a storage location of the still image in the image storage device; and
the display device displays the still image identified by the information that identifies the storage location of the still image included in the linkage information, simultaneously with reproduction of the contents by the reproduction device.

9. A print system which creates print data for printing a two-dimensional code embedded with linkage information that links a still image and contents with each other, and the still image linked with the contents by the linkage information embedded in the two-dimensional code, and which prints the two-dimensional code and the still image on a prescribed print medium according to the print data.

10. A contents server which stores contents in a storage location represented with information included in linkage information that links a still image and the contents with each other, and which sends the contents to a communication terminal that accesses to the contents server according to the linkage information embedded in a two-dimensional code printed on a prescribed print medium.
